(19) United States
(12) Patent Application Publication
(10) Pub. No.: US 2022/0357716 A1
(43) Pub. Date: Nov. 10, 2022

(54) SYSTEM FOR THE OPERATION OF A PRODUCTION MACHINE FOR PLASTICS PROCESSING

(71) Applicant: KIEFEL GMBH, Freilassing (DE)

(72) Inventors: Christian Lang, HAIGERMOOS (AT); Michael Schörghofer, BAD DÜRRNBERG (AT); Peter Knoll, Ainring (DE); Andreas Ainz, PLAINFELD (AT); Horst Hradetz, Ainring/Mitterfelden (DE)

(21) Appl. No.: 17/621,573

(22) PCT Filed: Jun. 22, 2020
(86) PCT No.: PCT/DE2020/000137

§ 371 Date: Dec. 21, 2021

(30) Foreign Application Priority Data
Jun. 25, 2019 (DE) 10 2019 117 095.8

(51) Int. Cl. G05B 19/409; G05B 19/418

(52) U.S. Cl. CPC G05B 19/409; G05B 19/41875; G05B 2219/32368

(57) ABSTRACT

The invention relates to an HMI system with a mobile operating and monitoring device for operating a production machine for plastics processing. The HMI system is installed on a control unit of the production machine and has a mobile operating and monitoring device.

### FIELD OF THE INVENTION

The invention relates to an HMI (Human-Machine Interface) system for operating a production machine for plastics processing. The invention further relates to a method of operating such an HMI, and to a data carrier having a control program stored thereon with a corresponding HMI.

### BACKGROUND OF THE INVENTION

Production machines are used in many areas of manufacturing. In plastics processing, for example, blow molding machines and thermoforming machines are used. In prior art thermoforming machines, which can accommodate different designs of molds for producing differently shaped moldings, different molding programs, referred to herein and hereinafter as formulas, must be used for production of the different moldings. The different moldings usually require different sets of process parameters for good quality production, which must be entered into the formulas. Here it may be necessary to adapt even a process parameter set known for the molding to the respective production and machine situation. If the operator changes machine parameters during the optimization of the production process, it would be desirable for a visualization to show the basic time sequence of the process taking place in the machine, so that the operator has less trouble classifying the effects of his actions in the current time sequence of the machine.

Human-machine interfaces (HMIs) are known that can show a schematic presentation of individual machine components in addition to the input fields in order to better illustrate the relevant process step to the operator.

Plastics processing machines are complex machines with a large number of machine components. Plastics processing processes can be influenced by a large number of process parameters. An experienced person skilled in the art is required to create a set of process parameters for the initial manufacture of a product. Many process parameters cannot be adjusted but must be accepted for a given production. For example, raw material properties can vary from batch to batch within a range of tolerance. In addition, many environmental conditions, such as ambient temperature and/or humidity, can only be kept constant within a window. In addition, many process parameters influence each other. As a result, a set of parameters that has been found once cannot always be used identically for the production of an article but must be adjusted anew for each new production order. But even within a production order, the parameter set must be optimized again and again. In this situation, it would be helpful if the operator were shown the effects of parameter changes on the process without delay.

### SUMMARY OF THE INVENTION

The invention is based on the task of providing an HMI system for operating a production machine for plastics processing, by means of which the effects of a parameter change can be displayed to an operator without delay. Furthermore, it is an object of the invention to disclose a method of operating a corresponding HMI system. A further object of the invention is to provide a data carrier on which a corresponding HMI system is stored.

The task of the invention is solved by an HMI system of a production machine for plastics processing with a plurality of machine components according to claim 1. Advantageous further embodiments of the HMI system result from claims 2 to 9. The further task of the invention is solved by a method according to claims 10 to 12. Claim 13 claims a data carrier according to the further aspect of the invention.

An inventive HMI system of a production machine for plastics processing having a plurality of machine components and a control unit, wherein the HMI system is operatively connected to the control unit of the production machine, wherein the production machine has a visualization unit on which data of the HMI system can be displayed, wherein in at least one of the machine components at least one sensor for recording measured values is provided and the HMI system is adapted to display the individual machine components and the measured values without delay.

The Following Definitions Apply:

An HMI is understood to be a human-machine interface. An HMI represents an interactive user interface. In addition to operating the machine, an HMI can allow the operator to observe the system status and intervene in the process. The information can be provided as feedback by means of software via a visualization system.

Production machines for plastics processing are, for example, blow molding machines or thermoforming machines. Blow molding machines produce a film tubing from heated plastic material. Thermoforming machines are used for the production of deep-drawn moldings and comprise a transport unit for a thermoplastic film web and a molding station for molding the moldings from the previously heated film web. Such machines are characterized by the fact that they comprise a large number of individual machine components that must interact appropriately, since a single tubing or web of film is fed through the entire production line and thus the machine components must be coordinated in their action and cycle time for a good overall process. Machine components for a thermoforming machine comprise, for example, the transport unit for film supply from a film reel, a preheating station for preheating the film web, a heating station for heating the film web to process temperature, a forming station for forming the product from the film web, a cutting station for cutting out the formed products from the film web, a stacking station for stacking the finished products and a recycling station for the unprocessed film web.

A visualization unit is a device on which data can be displayed optically. A visualization unit can be a screen, for example.

Due to the active connection of the HMI system to the control unit of the production machine, data can be exchanged between the HMI system and the control unit, in particular without delay. By means of the sensor for recording measured values in at least one machine component, data, in particular also meaningful data for the manufacturing quality of the produced plastic part, can be recorded. Due to the non-delay display of such data, the operator can promptly recognize the effects of a parameter change on the produced part quality. This allows the parameter optimization process to be accelerated, where in addition less scrap is produced during the parameter optimization process and thus resources, for example raw materials, energy and manpower, are saved.

The HMI system can be installed on the control unit of the production machine or on a separate device, for example a separate computer or server system.

In an advantageous embodiment, the HMI system is adapted to display a simulation of a manufacturing process, wherein the simulation can be influenced by entering or changing process parameters. This enables an operator to, for example, create a set of parameters for the initial production of an item for the production machine without the production machine being started. This means that the HMI system can perform tests without the production machine actually producing and possibly also producing rejects, consuming resources or running the risk of damaging the production machine.

In an advantageous embodiment, the HMI system further comprises a mobile operating and monitoring device, wherein the HMI system is set up to establish and maintain a real-time connection between the control unit of the production machine and the mobile operating and monitoring device. Here, “real-time connection” means that the connection functions in such a way that data is exchanged between the mobile operating and monitoring device and the control unit without any significant delay. However, small delays are possible depending on the connection technology used. Due to use of the real-time connection, it is also possible to follow very quickly from a distance on the mobile operating and monitoring device how parameter changes affect the manufacturing process. If the manufacturing process is a discontinuous one, such as a thermoforming process, the real-time connection makes it possible to observe the effects of a parameter change on the mobile operating and monitoring device as early as the next cycle, or at the latest the cycle after that, after the parameter change. The fact that the HMI has a mobile operating and observation device means that a third party, such as a person skilled in the art, can provide an operator on site with assistance in setting up or optimizing the production machine without having to be on site themselves. Unfortunately, even in highly developed industrial nations there is a shortage of skilled workers. In less developed countries, this shortage of skilled workers is disastrous. Therefore, it is advantageous if a person skilled in the art can provide appropriate assistance from a distance. In particular, the third party can also be, for example, a specialist from the manufacturer of the production machine, who can, for example, provide the assistance to a remote operator on site, in particular also abroad, from his place of work at the manufacturer of the production machine. The HMI system can be set up to display individual machine components. The individual machine components can be components that contribute directly to production. However, the production machine may also have machine components that do not directly contribute to production, but are for example quality monitoring components, such as optical quality monitoring components, for example cameras, or weight monitoring components, for example scales, or geometry monitoring components, and so on. Through the display of these components, a remote third party can also get a vivid impression of the production machine on site and the production process.

In an advantageous embodiment, the real-time connection is made via a wireless connection technology. Wireless connection technologies are, for example, mobile radio or wireless internet (W-LAN). By using a wireless connection technology, the mobility of the mobile operating and monitoring device is increased.

In a further advantageous embodiment, the mobile operating and monitoring device is set up to receive data inputs and forward them to the control unit of the production machine without delay. This makes it possible for a third party to change manufacturing parameters on the mobile operating and monitoring device, where these are incorporated into the manufacturing process without delay.

In another advantageous embodiment, the HMI system is set up to forward actual data from the control unit of the production machine to the mobile operating and monitoring device. This actual data can be displayed on the mobile operating and monitoring device, in particular in real time, so that the third party can directly observe the effects of a parameter change via the mobile operating and monitoring device.

In another advantageous embodiment, a chat function between several mobile operating and monitoring devices and/or between a mobile operating and monitoring device and the local visualization unit is also integrated into the HMI system. This facilitates communication, for example, between a locally remote assistant operator and an operator on site.

In a further advantageous embodiment, the HMI system is set up to receive quality information locally at the production machine and to forward it to the mobile operating and monitoring device without delay, where the mobile operating and monitoring device is set up to display the quality information without delay.

It has further proven advantageous if the mobile operating and monitoring device is set up to establish a connection with several HMI systems. This makes it possible, for example, for the person skilled in the art to provide on-site assistance to operators for setting and optimizing process parameters for a number of production machines, but only requires one mobile operating and monitoring device for this purpose.

In an advantageous embodiment, the mobile operating and monitoring device is a mobile phone, a tablet or a mobile computer. Modern mobile phones in the form of “smartphones” offer similar functionalities as tablets or notebooks. A tablet or tablet computer is a computer in tablet form with a visualization unit in the form of a screen that is usually touch-sensitive and thus also suitable as an input device. In addition, an external keyboard can also be connected to common tablets for data input. Mobile computers are known as notebooks. All devices are commercially available devices on which a program or app can be loaded that enables the device to act as a display and input device for the HMI.

A method according to the invention for operating an HMI system for a production machine for plastics processing with a control unit, wherein the HMI system is operatively connected to the control unit of the production machine and wherein the HMI system has a visualization unit on which data of the HMI system can be displayed, and the production machine has individual machine components, wherein in at least one of the individual machine components at least one sensor is provided for recording measured values and the HMI system is set up to display the individual machine components and the measured values, is characterized by a non-delay exchange of data between the control unit of the production machine and the HMI system, the display of individual machine components of the production machine on the visualization unit and the display of relevant process parameters of the individual machine components as desired and actual values on the visualization unit, wherein the desired values of the relevant process parameters can be changed by means of the visualization unit and altered actual values are displayed without delay on the visualization unit.

In an advantageous embodiment of the method, the HMI system additionally has a mobile operating and monitoring device, wherein the HMI system exchanges data between the mobile operating and monitoring device without delay and data can be entered locally on the visualization unit, wherein this data is displayed on the mobile operating and monitoring device without delay.

In an advantageous embodiment of the method, information can be entered locally, i.e. on site at the production machine, where this information is displayed without delay on the mobile operating and monitoring device.

The invention further relates to a data carrier with a control program stored thereon with the HMI described above.

It is understood that features of the solutions described above or in the claims can also be combined, if necessary, in order to be able to implement the advantages and effects achievable herein in a correspondingly cumulative manner.

### BRIEF DESCRIPTION OF THE FIGURES

In addition, further features, effects and advantages of the present invention are explained with reference to the accompanying drawing and the following specification.

The Drawing Shows:

FIG. 1 Schematic diagram of a production machine with visualization unit and a mobile operating and monitoring device.

### EXAMPLE OF EMBODIMENT

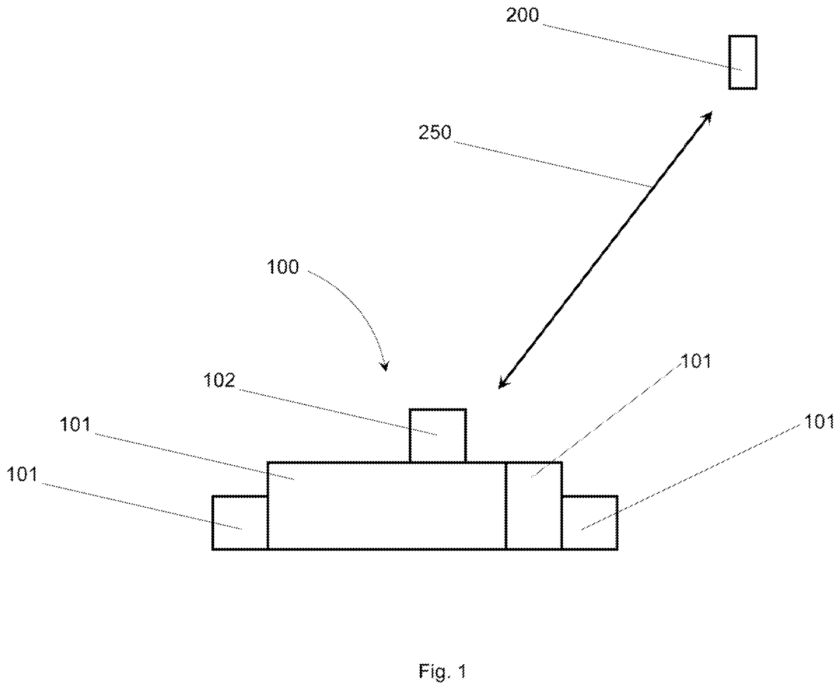

FIG. 1 shows a schematic drawing of a production machine 100 and a mobile operating and monitoring device 200. The production machine 100 is a production machine 100 for plastics processing with a plurality of machine components 101. The production machine 100 has a control unit and a visualization unit 102. Furthermore, the HMI system comprises a mobile operating and monitoring device 200. This mobile operating and monitoring device can be, for example, a mobile phone, a tablet or a mobile computer. There is a wireless connection 250 between the mobile operating and observation device 200 and the production machine 100. Via the wireless connection, data is exchanged in real time between the mobile operating and monitoring device and the control unit of the production machine 100. The mobile operating and monitoring device 200 is adapted to receive data inputs and to forward them to the control unit of the production machine 100 without delay. Furthermore, the HMI system is set up to forward actual data from the control unit of the production machine 100 to the mobile operating and monitoring device 200. One or more of the machine components 101 can generate quality information and forward it to the control unit of the production machine 100, from where it can be forwarded to the mobile operating and monitoring device 200 without delay. The mobile operating and monitoring device 200 is set up to display the quality information without delay.

At this point, it should be explicitly pointed out that features of the solutions described above or in the claims and/or figures can also be combined, if necessary, so that the features, effects and advantages explained can also be achieved or implemented, respectively, in a correspondingly cumulative manner.

It is understood that the exemplary embodiment explained above is only a first embodiment of the present invention. Consequently, the embodiments of the invention are not limited to this example.

### LIST OF REFERENCE NUMBERS

100 Production machine
101 Machine component
102 Visualization unit
200 Mobile operating and monitoring device
250 Wireless connection

1. HMI system for a production machine for plastics processing with a plurality of machine components and a control unit, wherein the HMI system is operatively connected to the control unit of the production machine, wherein the production machine has a visualization unit, on which data of the HMI system can be displayed, at least one sensor for recording measured values being provided in at least one of the machine components, and the HMI system being set up to display the individual machine components and the measured values without delay.

2. HMI system according to claim 1, wherein
the HMI system is set up to display a simulation of a manufacturing process, where it is possible to influence the simulation by inputting or changing process parameters.

3. HMI system according to claim 1, wherein
the HMI system further comprises a mobile operating and monitoring device, wherein the HMI system is adapted to establish and maintain a real-time connection between the control unit of the production machine and the mobile operating and monitoring device.

4. HMI system according to claim 3, wherein
the real-time connection is made via a wireless connection technology.

5. HMI system according to claim 1, wherein
the mobile operating and monitoring device is set up to receive data inputs and to forward them without delay to the control unit of the production machine.

6. HMI system according to claim 1, wherein
a chat function between a plurality of mobile operating and monitoring devices and/or between a mobile operating and monitoring device and the local visualization unit is further integrated into the HMI system.

7. HMI system according to claim 1, wherein
the HMI system is set up to receive quality information locally at the production machine and to forward it to the mobile operating and monitoring device without delay, the mobile operating and monitoring device being set up to display the quality information without delay.

8. HMI system according to claim 1, wherein
the mobile operating and monitoring device is adapted to establish a connection with several HMI systems.

9. HMI system according to claim 1, wherein
the mobile operating and monitoring device is a mobile phone, a tablet or a mobile computer.

10. Method of operating an HMI system for a production machine for plastics processing with a control unit, wherein the HMI system is operatively connected to the control unit of the production machine, wherein the HMI system comprises a visualization unit on which data of the HMI system can be displayed, and the production machine having individual machine components, at least one sensor for recording measured values being provided in at least one of the individual machine components, and the HMI system being set up to display the individual machine components and the measured values, wherein
a non-delay exchange of data between the control unit of the production machine and the HMI system,
displaying individual machine components of the production machine on the visualization unit,
displaying relevant process parameters of the individual machine components as desired and actual values on the visualization unit, wherein the desired values of the relevant process parameters can be changed by means of the visualization unit and altered actual values are displayed without delay on the visualization unit.

11. Method according to claim 10, wherein
the HMI system additionally has a mobile operating and monitoring device, the HMI system exchanging data between the mobile operating and monitoring device and the control unit without delay, and data being able to be entered locally at the visualization unit, these data being displayed on the mobile operating and monitoring device without delay.

12. Method according to claim 11, wherein
data can be input on the mobile operating and monitoring device, these data being displayed without delay on the visualization unit.

13. Data carrier with a control program with HMI stored thereon according to claim 1.

14. HMI system according to claim 1,
wherein the HMI system is set up to forward actual data from the control unit of the production machine to the mobile operating and monitoring device.
